(19) United States
(12) Patent Application Publication
(10) Pub. No.: US 2013/0242178 A1
(43) Pub. Date: Sep. 19, 2013

(54) OPTICAL MODULE FOR IMAGE MEASURING APPARATUS

(71) Applicants: CHIH-KUANG CHANG, Tu-Cheng (TW); DONG-HAI LI, Shenzhen City (CN); LI JIANG, Shenzhen City (CN); JIAN-HUA LIU, Shenzhen City (CN); DONG-SHENG LIU, Shenzhen City (CN)

(72) Inventors: CHIH-KUANG CHANG, Tu-Cheng (TW); DONG-HAI LI, Shenzhen City (CN); LI JIANG, Shenzhen City (CN); JIAN-HUA LIU, Shenzhen City (CN); DONG-SHENG LIU, Shenzhen City (CN)

(21) Appl. No.: 13/664,607

(22) Filed: Oct. 31, 2012

(30) Foreign Application Priority Data
Mar. 14, 2012 (CN) 201210066115.1

(51) Int. Cl. G02B 27/12; H04N 5/225

(52) U.S. Cl. 348/370; 359/639; 359/640; 348/E05.024

(57) ABSTRACT

An optical module includes a first sleeve, a second sleeve, a connecting member and a beam splitter. The first sleeve defines a first hollow cavity and includes a first light source and a pattern plate. The second sleeve defines a second hollow cavity and a second light source. The connecting member is connected to the first sleeve and the second sleeve, and communicates with the first hollow cavity and the second hollow cavity. The beam splitter is positioned in the connecting member. Light from the first light source passes through the pattern plate, and the beam splitter, light from the second light source passes through the beam splitter, the beam splitter refracts the light from the first light source and the second light source to a tested workpiece.

### BACKGROUND

1. Technical Field

The present disclosure relates to optical systems, and more particularly, to an optical module used for an image measuring apparatus.

2. Description of related art

Image measuring apparatus usually includes an optical module for imaging a tested workpiece. However, when the workpiece has a high smoothness (e.g. a glass), the optical module has difficulty focusing the workpiece and cannot accurately finish the measuring requirement.

Therefore, there is room for improvement within the art.

### BRIEF DESCRIPTION OF THE DRAWINGS

Many aspects of the disclosed optical module can be better understood with reference to the following drawings. The components in the drawings are not necessarily drawn to scale, the emphasis instead being placed upon clearly illustrating the principles of the present optical module.

FIG. 1 is a schematic view of an optical module according to an exemplary embodiment.

FIG. 2 is a cross sectional view of the optical module in FIG. 1 for imaging an workpiece.

### DETAILED DESCRIPTION

The disclosed optical module 100 is used in an image measuring apparatus, although the disclosure is not limited thereto.

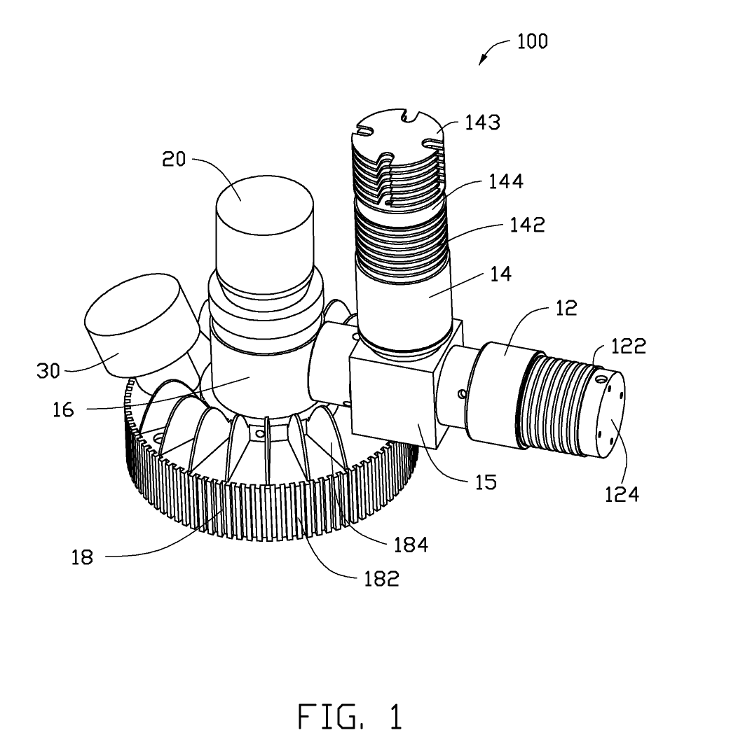

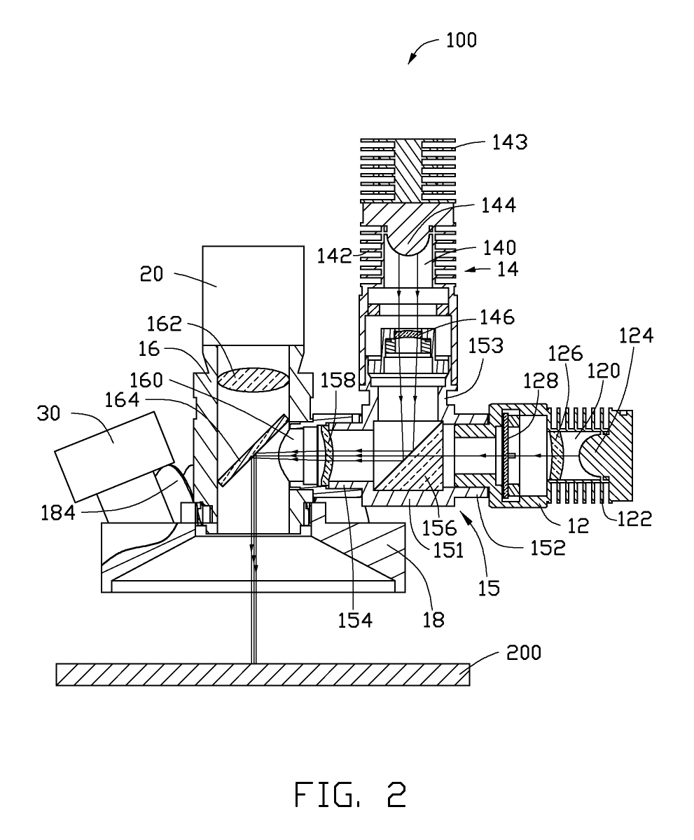

Referring to FIGS. 1 and 2, the optical module 100 includes a first sleeve 12, a second sleeve 14, a connecting member 15, a lens barrel 16, a main light source 18, an image sensor 20 and a camera 30. The connecting member 15 is connected to one side of the lens barrel 16. The first sleeve 12 and the second sleeve 14 are connected to the connecting member 15.

The first sleeve 12 defines a first hollow cavity 120. A plurality of heat dissipating fins 122 are positioned parallel to each other and positioned along an outside peripheral wall of the first sleeve 12. A first light source 124, a first lens 126, and a pattern plate 128 are orderly positioned in the first hollow cavity 120. The first light source 124 is positioned at one end of the first sleeve 12 for illuminating the pattern plate 128. When the first light source 124 emits light, the first lens 126 allows light emitted by the first light source 124 to uniformly pass. The pattern plate 128 is used for imaging the pattern of the pattern plate 128 on a tested workpiece.

The second sleeve 14 includes a second hollow cavity 140. A second light source 144 and a second lens 146 are positioned in the hollow second cavity 140. A plurality of heat dissipating fins 142 and 143 are respectively positioned along an outside peripheral wall of the second sleeve 14 and one end of the second light source 144. When the second light source 144 emits light, the second lens 146 allows light emitting by the second light source 144 to uniformly pass. In the exemplary embodiment, the first light source 124 and the second light source 144 are LEDs.

The connecting member 15 is configured for connecting the first sleeve 12, the second sleeve 14 and the lens barrel 16. The connecting member 15 includes a main body 151, a first connecting portion 152, a second connecting portion 153, and a third connecting portion 154 integrally formed together. The first connecting portion 152 and the third connecting portion 154 are co-axial, and the first connecting portion 152 is connected to the first sleeve 12. The second connecting portion 153 is connected to the second sleeve 14. The third connecting portion 154 is connected to the lens barrel 16. A third lens 158 is positioned in the third connecting portion 154. A beam splitter 156 is positioned at the main body 151. The light emitted by the second light source 144 can be perpendicularly refracted by the beam splitter 156 and pass the third lens 158 to enter the lens barrel 16. The light emitted by the first light source 124 can pass the beam splitter 156 and the third lens 158 to enter the lens barrel 16.

The lens barrel 16 defines an opening 160 communicating with the third connecting portion 154. At least one image lens 162 and a prism 164 are positioned in the lens barrel 16. One end of the lens barrel 16 is connected to the image sensor 20, and another end of the lens barrel 16 is connected to the main light source 18. In the exemplary embodiment, the image sensor 20 is a charge coupled device.

The main light source 18 is an annular light source for illuminating the workpiece 200. The camera 30 is positioned on the main light source 18, and can image the workpiece 200. A plurality of ribs 182 are located on a peripheral wall of the main light source 18, and a plurality of arcuate heat dissipating sheets 184 are located on a top wall of the main light source 18.

In use, when the tested workpiece has a high smoothness, the first light source 124 is firstly turned on. The light emitted by the first light source 124 passes the first lens 126, and illuminates the pattern plate 128. Then, the light passes the beam splitter 156, and the third lens 158 to enter the lens barrel 16. The prism 164 refracts the pattern light on the workpiece 200 for conveniently focusing the workpiece. After the workpiece 200 is focused, the first light source 124 is turned off, and the second light source 144 and the main light source 18 are turned on. The main light source 18 illuminates the workpiece 200. The light emitted by the second light source 144 passes the second lens 146 and the beam splitter 156, and perpendicularly refracts into the lens barrel 16. The prism 164 refracts the light emitted by the second light source 144 on the workpiece 200. The image of the workpiece 200 is caught by the image lens 162 and the image sensor 20, for providing the image measuring apparatus.

When the tested workpiece has a low smoothness, the first light source 124 does not need to be turned on, and only the second light source 144 and the main light source 18 are opened for finishing the image process. The optical module 100 has a first light path, in which, the light from the first light source 124 passes through the first lens 126, the pattern plate 128, the beam splitter 156 and the prism 164, and is refracted to the tested workpiece 200. A second light path is defined, in which, the light from the second light source 144 passes through the second lens 146 and the beam splitter 156, the beam splitter 156 refracts the light from the second light source 144 to the third lens 158 and the prism 164, the prism 164 refracts the light to the tested workpiece 200. The optical module 100 in the present disclosure can image the patter on the pattern plate 128 on a smooth workpiece for conveniently focusing the smooth workpiece, and can have a more accurate test result.

It is to be understood, however, that even through numerous characteristics and advantages of the present disclosure have been set forth in the foregoing description, together with details of assembly and function, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An optical module comprising:
a first sleeve, defining a first hollow cavity, comprising a first light source and a pattern plate received in the first hollow cavity;
a second sleeve defining a second hollow cavity and a second light source received in the second hollow cavity;
a connecting member, connected to the first sleeve and the second sleeve, and communicating with the first hollow cavity and the second hollow cavity;
a beam splitter positioned in the connecting member;
wherein light from the first light source passes through the pattern plate and the beam splitter, light from the second light source passes through the beam splitter, the beam splitter refracts the light from the first light source and the second light source to a tested workpiece.

2. The optical module as claimed in claim 1, wherein a plurality of heat dissipating fins are positioned parallel to each other and positioned along an outside peripheral wall of the first sleeve and the second sleeve.

3. The optical module as claimed in claim 2, wherein the connecting member comprises a main body, a first connecting portion, a second connecting portion, and a third connecting portion integrally formed together; the first connecting portion and the third connecting portion are co-axial, and the first connecting portion is connected to the first sleeve; the second connecting portion is connected to the second sleeve; and the beam splitter is positioned in the main body.

4. The optical module as claimed in claim 3, further comprising a lens barrel, wherein the third connecting portion is connected to the lens barrel.

5. The optical module as claimed in claim 4, wherein at least one image lens and a prism are positioned in the lens barrel, one end of the lens barrel is connected to an image sensor, and another end of the lens barrel is connected to a main light source.

6. The optical module as claimed in claim 5, wherein the image sensor is a charge coupled device.

7. The optical module as claimed in claim 6, wherein a plurality of ribs are located on a peripheral wall of the main light source, and a plurality of arcuate heat dissipating sheets are located on a top wall of the main light source.

8. An image measuring apparatus comprising:
an optical module comprising:
a first sleeve comprising a first light source and a pattern plate;
a second sleeve comprising a second light source;
a connecting member connected to the first sleeve and the second sleeve, and communicating with each other; and
a beam splitter positioned in the connecting member;
a lens barrel connected to the connecting member of the optical module, the lens barrel including a prism; and
a main source connected to the lens barrel;
wherein when light is emitted from the first light source, light passes through the pattern plate, the beam splitter and the prism, and the prism refracts the light from the first light source to a tested workpiece; and when light is emitted from the second light source, light passes through the beam splitter, the beam splitter refracts the light from the second light source to the prism, the prism refracts the light to the tested workpiece.

9. The image measuring apparatus as claimed in claim 8, wherein the third connecting portion is connected to the lens barrel, at least one image lens is positioned in the lens barrel adjacent to the prism, one end of the lens barrel is connected to an image sensor, and another end of the lens barrel is connected to the main light source.

10. The image measuring apparatus as claimed in claim 9, wherein a plurality of ribs are located on a peripheral wall of the main light source, and a plurality of arcuate heat dissipating sheets are located on a top wall of the main light source.

11. An image measuring apparatus comprising:
a first sleeve comprising a first light source and a pattern plate;
a second sleeve including a second light source;
a connecting member connected to the first sleeve and the second sleeve;
a beam splitter positioned in the connecting member;
a lens barrel connected to the connecting member, the lens barrel including a prism;
wherein a first light path is that light from the first light source passes through the pattern plate, the beam splitter and the prism, and is refracted to a tested workpiece, a second light path is that light from the second light source passes through the beam splitter, the beam splitter refracts the light from the second light source to the prism, the prism refracts the light from the second source to the tested workpiece.
